(19) United States
(12) Patent Application Publication
(10) Pub. No.: US 2024/0365157 A1
(43) Pub. Date: Oct. 31, 2024

(54) COMMUNICATION METHOD AND DEVICE

(71) Applicant: GUANGDONG OPPO MOBILE TELECOMMUNICATIONS CORP., LTD., Dongguan (CN)

(72) Inventors: Xue LIN, Dongguan (CN); Yi HU, Dongguan (CN); Xin YOU, Dongguan (CN)

(21) Appl. No.: 18/771,094

(22) Filed: Jul. 12, 2024

Related U.S. Application Data
(63) Continuation of application No. PCT/CN2022/072126, filed on Jan. 14, 2022.

(51) Int. Cl. H04W 24/10; H04B 7/08; H04W 74/0833

(52) U.S. Cl. CPC H04W 24/10; H04B 7/088; H04W 74/0833

(57) ABSTRACT

A communication method includes: reporting, by a terminal device, beam information in a case that a first condition is met, in SDT.

### CROSS-REFERENCE TO RELATED APPLICATION

This application is a Continuation Application of International Application No. PCT/CN2022/072126 filed on Jan. 14, 2022, which is incorporated herein by reference in its entirety.

### TECHNICAL FIELD

The present disclosure relates to the field of communication, and more particularly, to a communication method and device.

### RELATED ART

An early data transmission (EDT) may also be referred to as a small data transmission (SDT). During the procedure, a UE may always remain in an idle state, a suspended state or an inactive state, to complete a transmission of an uplink and/or downlink small data packet. In a procedure of the SDT, it is necessary to consider how to perform beam reporting.

### SUMMARY

Embodiments of the present disclosure provide a communication method and device.

The embodiments of the present disclosure provide a communication method, including:
reporting, by a terminal device, beam information in a case where a first condition is met, in a small data transmission (SDT).

The embodiments of the present disclosure provide a communication method, including:
transmitting, by a network device, first indication information, where the first indication information is used for indicating beam reporting-related information.

The embodiments of the present disclosure provide a communication device, including:
a processing unit, configured to report beam information in a case where a first condition is met, in a small data transmission (SDT).

The embodiments of the present disclosure provide a communication device, including:
a first transmitting unit, configured to transmit first indication information, where the first indication information is used for indicating beam reporting-related information.

The embodiments of the present disclosure provide a terminal device, including a processor and a memory. The memory is configured to store a computer program, and the processer is configured to invoke and execute the computer program stored in the memory, to cause the terminal device to perform the communication method of any one of the embodiments of the present disclosure.

The embodiments of the present disclosure provide a network device, including a processor and a memory. The memory is configured to store a computer program, and the processer is configured to invoke and execute the computer program stored in the memory, to cause the network device to perform the communication method of any one of the embodiments of the present disclosure.

The embodiments of the present disclosure provide a chip, configured to implement the communication method mentioned above. Exemplarily, the chip includes a processor, and the processor is configured to invoke and execute a computer program from a memory, to cause a device equipped with the chip to perform the communication method of any one of the embodiments of the present disclosure.

The embodiments of the present disclosure provide a computer readable storage medium for storing a computer program, and the computer program, when being executed by a device, causes the device to perform the communication method of any one of the embodiments of the present disclosure.

The embodiments of the present disclosure provide a computer program product, including a computer program instruction, where the computer program instruction causes a computer to perform the communication method of any one of the embodiments of the present disclosure.

The embodiments of the present disclosure provide a computer program, where the computer program, when being executed by a computer, causes the computer to perform the communication method of any one of the embodiments of the present disclosure.

### BRIEF DESCRIPTION OF THE DRAWINGS

FIG. 1 is a schematic diagram of an application scenario according to the embodiments of the present disclosure.

FIG. 2 is a schematic diagram of a mobile originated early data transmission (MO-EDT) air interface procedure.

FIG. 3 is a schematic diagram of a mobile terminated early data transmission (MT-EDT) procedure.

FIG. 4 is a schematic diagram of a beam coverage range.

FIG. 5 is a schematic flowchart of a communication method according to an embodiment of the present disclosure.

FIG. 6 is a schematic flowchart of a communication method according to another embodiment of the present disclosure.

FIG. 7 is a schematic flowchart of a communication method according to an embodiment of the present disclosure.

FIG. 8 is a schematic flowchart of a communication method according to another embodiment of the present disclosure.

FIG. 9 is a schematic block diagram of a terminal device according to an embodiment of the present disclosure.

FIG. 10 is a schematic block diagram of a terminal device according to another embodiment of the present disclosure.

FIG. 11 is a schematic block diagram of a network device according to an embodiment of the present disclosure.

FIG. 12 is a schematic block diagram of a network device according to another embodiment of the present disclosure.

FIG. 13 is a schematic block diagram of a communication device according to the embodiments of the present disclosure.

FIG. 14 is a schematic block diagram of a chip according to the embodiments of the present disclosure.

FIG. 15 is a schematic block diagram of a communication system according to the embodiments of the present disclosure.

### DETAILED DESCRIPTION

Technical solutions in the embodiments of the present disclosure will be described below in conjunction with the drawings in the embodiments of the present disclosure.

The technical solutions of the embodiments of the present disclosure may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Networks (WLAN), a Wireless Fidelity (WiFi), a fifth-generation communication (5th-Generation, 5G) system, or other communication systems, etc.

Generally speaking, a number of connections supported by a traditional communication system is limited and is easy to implement, however, with the development of the communication technology, the mobile communication system will not only support the traditional communication, but also support, for example, Device to Device (D2D) communication, Machine to Machine (M2M) communication, Machine Type Communication (MTC), Vehicle to Vehicle (V2V) communication, or Vehicle to everything (V2X) communication, etc, and the embodiments of the present disclosure may also be applied to these communication systems.

In an implementation, the communication system in the embodiments of the present disclosure may be applied to a carrier aggregation (CA) scenario, may also be applied to a dual connectivity (DC) scenario, and may also be applied to a standalone (SA) network deployment scenario.

In an implementation, the communication system in the embodiments of the present disclosure may be applied to an unlicensed spectrum, where the unlicensed spectrum may also be considered as a shared spectrum; or the communication system in the embodiments of the present disclosure may also be applied to a licensed spectrum, where the licensed spectrum may also be considered as an unshared spectrum.

The embodiments of the present disclosure describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, ST) in the WLAN, may be a cellular phone, a cordless phone, a Session Initiation Protocol (SIP) phone, a Wireless Local Loop (WLL) station, or a personal digital assistant (PDA) device, a handheld device with a wireless communication function, a computing device or other processing devices connected to a wireless modem, a vehicle-mounted device, a wearable device, a terminal device in a next generation communication system such as in an NR network, or a terminal device in a Public Land Mobile Network (PLMN) network evolved in the future, etc.

In the embodiments of the present disclosure, the terminal device may be deployed on land, which includes indoor or outdoor, in handheld, worn or vehicle-mounted; may also be deployed on water (e.g., on a ship, etc.); may also be deployed in the air (e.g., on an airplane, a balloon, a satellite, etc.).

In the embodiments of the present disclosure, the terminal device may be a mobile phone, a pad, a computer with a wireless transceiving function, a Virtual Reality (VR) terminal device, an Augmented Reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, etc.

As an example but not a limitation, in the embodiments of the present disclosure, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses, etc., with full functions, large size, and entire or partial functions without relying on a smartphone, as well as, for example, a smart bracelet and smart jewelry for physical sign monitoring, which only focuses on a certain type of disclosure function and needs to be used in conjunction with other devices such as a smartphone.

In the embodiments of the present disclosure, the network device may be a device used for communicating with a mobile device. The network device may be an Access Point (AP) in the WLAN, a base station (Base Transceiver Station, BTS) in the GSM or CDMA, may also be a base station (NodeB, NB) in the WCDMA, or may also be an evolutionary base station (Evolutionary Node B, eNB or eNodeB) in the LTE, or a relay station or an access point, or a network device (gNB) in a vehicle-mounted device, a wearable device and an NR network, or a network device in the PLMN network evolved in the future or a network device in the NTN network, etc.

As an example but not a limitation, in the embodiments of the present disclosure, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station provided on land, water, and other places.

In the embodiments of the present disclosure, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc, these small cells have characteristics of small coverage range and low transmission power, which are applicable for providing a data transmission service with high speed.

The embodiments of the present disclosure provide a communication method, and the method includes:
reporting, by a terminal device, beam information in a case where a first condition is met, in a small data transmission (SDT).

In some embodiments, where reporting the beam information in the case where the first condition is met includes:
reporting beam measurement information or initiating a contention-based random access procedure in a case where a first timer expires.

In some embodiments, a manner of starting or restarting the first timer includes at least one of:
restarting, by the terminal device, the first timer, after the first timer expires; or
restarting, by the terminal device, the first timer, after the reporting of the beam measurement information is completed.

In some embodiments, the first timer is used to control a time interval for periodic beam information reporting.

In some embodiments, a manner of starting or restarting the first timer includes at least one of:
restarting/starting the first timer, if the terminal device receives downlink data transmitted by a network device;
restarting/starting the first timer, if the terminal device initiates a random access procedure and receives a contention-conflict resolution message fed back by a network device; or
restarting the first timer, if the terminal device performs an uplink transmission by using a configured grant (CG) resource and receives feedback from a network device, during the first timer is running.

In some embodiments, the first timer is used to monitor a time at which the network device is not in communication with the terminal device.

In some embodiments, the first timer is stopped in at least one of cases of:
an RRC message being received by the terminal device, and the RRC message indicating to end a procedure of the SDT; or
failure of the SDT occurring at the terminal device.

In some embodiments, the failure of the SDT includes at least one of:
cell reselection occurring in a procedure of the SDT; or
an SDT failure timer expiring.

In some embodiments, where reporting the beam information in the case where the first condition is met includes:
reporting beam measurement information or initiating a contention-based random access procedure based on a first event and/or a second event.

In some embodiments, the first event includes that a beam with best wireless link quality changes.

In some embodiments, a manner of determining whether the beam with the best wireless link quality changes includes:
acquiring latest beam measurement results, to determine the beam with the best wireless link quality;
comparing whether the beam with the best wireless link quality is the same as a beam selected under a first operation, where the first operation includes at least one of: a last measurement, a last initiation of a random access procedure, a last transmission using CG; and
determining that the beam with the best wireless link quality changes, in a case where the beam with the best wireless link quality is not the same as the beam selected under the first operation.

In some embodiments, the second event includes at least one of:
wireless link quality of a beam with best wireless link quality being below a first threshold; or
there being wireless link quality of at least one beam above a second threshold.

In some embodiments, the beam measurement information includes at least one of:
an index of a first beam;
a list of indices of first beams, including indices of first N beams in order of wireless link quality from good to bad;
a list of indices of second beams, including a set of indices of beams meeting a third threshold; or
a beam measurement result corresponding to an index of a beam.

In some embodiments, the first beam is a beam with best wireless link quality among all beams.

In some embodiments, an evaluation metric of the wireless link quality includes at least one of the following beam measurement results: reference signal receiving power (RSRP), reference signal receiving quality (RSRQ), or signal to interference plus noise ratio (SINR).

In some embodiments, the N is carried in a broadcast message and/or a first feedback message; and/or
the third threshold is carried in a broadcast message and/or a first feedback message.

In some embodiments, the beam measurement information is carried in a first MAC CE.

In some embodiments, the method further includes:
triggering, by the terminal device, a scheduling request (SR) based on the first MAC CE in a case of no uplink transmission resource, to trigger a random access procedure to acquire an uplink transmission resource.

In some embodiments, the beam measurement information is reported via a physical random access channel (PRACH) resource of a transmission preamble of the contention-based random access procedure.

In some embodiments, the terminal device is in a radio resource control inactive (RRC_INACTIVE) state or a radio resource control idle (RRC_IDLE) state.

In some embodiments, a reference signal corresponding to a beam is a synchronization signal block (SSB) and/or a channel status indicator reference signal (CSI-RS) transmitted in a broadcast message.

In some embodiments, the method further includes:
receiving, by the terminal device, a first paging message of a current resident cell.

In some embodiments, the first paging message includes at least one of: a terminal device
identifier, or a mobile terminated (MT)-small data transmission (SDT) indication.

In some embodiments, the method further includes:
initiating, by the terminal device, a procedure of the small data transmission (SDT).

In some embodiments, the procedure of the small data transmission includes:
transmitting first uplink data to a network device by using a first uplink resource.

In some embodiments, the first uplink resource includes at least one of the following resource types:
uplink (UL) grant indicated in a random access response (RAR) in a four-step random access procedure;
a physical uplink shared channel (PUSCH) associated with a preamble in a two-step random access procedure; or
a configured grant (CG)-SDT resource.

In some embodiments, the first uplink data at least includes a first RRC message.

In some embodiments, the first RRC message is an RRC resume request message.

In some embodiments, the method further includes:
receiving, by the terminal device, first indication information, where the first indication information is used for indicating beam reporting-related information.

In some embodiments, the beam reporting-related information includes at least one of:
whether to start a beam reporting procedure; or
a beam reporting-triggered manner.

In some embodiments, the first indication information is carried in a broadcast message and/or a first feedback message.

In some embodiments, the first feedback message includes at least one of: downlink control information (DCI), a media access control (MAC) control element (CE), or an RRC message.

In some embodiments, the first feedback message includes at least one of:
a contention-collision resolution successful identifier; or
second indication information used for indicating to the terminal device that first uplink data is successfully received.

In some embodiments, the second indication information includes at least one of: downlink data, an uplink new transmission schedule, or a downlink MAC CE.

In some embodiments, the downlink MAC CE is a timing advance command (TAC) MAC CE.

In some embodiments, a beam reporting-triggered manner includes timer triggering, and the timer triggering is used for indicating the terminal device to report beam measurement information or initiate a contention-based random access procedure in a case where a first timer expires.

In some embodiments, a beam reporting-triggered manner includes event triggering, and the event triggering is used for indicating the terminal device to report beam measurement information or initiate a contention-based random access procedure based on a first event and/or a second event.

The embodiments of the present disclosure provide a communication method, and the method includes:
transmitting, by a network device, first indication information, wherein the first indication information is used for indicating beam reporting-related information.

In some embodiments, the beam reporting-related information includes at least one of:
whether to start a beam reporting procedure; or
a beam reporting-triggered manner.

In some embodiments, the first indication information is carried in a broadcast message and/or a first feedback message.

In some embodiments, the first feedback message includes at least one of: downlink control information (DCI), a media access control (MAC) control element (CE), or an RRC message.

In some embodiments, the first feedback message includes at least one of:
a contention-collision resolution successful identifier; or
second indication information used for indicating to the terminal device that first uplink data is successfully received.

In some embodiments, the second indication information includes at least one of: downlink data, an uplink new transmission schedule, or a downlink MAC CE.

In some embodiments, the downlink MAC CE is a timing advance command (TAC) MAC CE.

In some embodiments, the beam reporting-triggered manner includes timer triggering, and the timer triggering is used for indicating the terminal device to report beam measurement information or initiate a contention-based random access procedure in a case where a first timer expires.

In some embodiments, the beam reporting-triggered manner includes event triggering, and the event triggering is used for indicating the terminal device to report beam measurement information or initiate a contention-based random access procedure based on a first event and/or a second event.

In some embodiments, the first event includes that a beam with best wireless link quality changes.

In some embodiments, the second event includes at least one of:
wireless link quality of a beam with best wireless link quality being below a first threshold; or
there being wireless link quality of at least one beam above a second threshold.

In some embodiments, the beam measurement information includes at least one of:
an index of a first beam;
a list of indices of first beams, including indices of first N beams in order of wireless link quality from good to bad;
a list of indices of second beams, including a set of indices of beams meeting a third threshold; or
a beam measurement result corresponding to an index of a beam.

In some embodiments, the first beam is a beam with best wireless link quality among all beams.

In some embodiments, an evaluation metric of the wireless link quality includes at least one of the following beam measurement results: reference signal receiving power (RSRP), reference signal receiving quality (RSRQ), or signal to interference plus noise ratio (SINR).

In some embodiments, the beam measurement information is carried in a first MAC CE.

In some embodiments, the beam measurement information is reported via a PRACH resource of a transmission preamble of the contention-based random access procedure.

In some embodiments, the terminal device is in a radio resource control inactive (RRC_INACTIVE) state or a radio resource control idle (RRC_IDLE) state.

In some embodiments, a reference signal corresponding to a beam is an SSB and/or a CSI-RS transmitted in a broadcast message.

In some embodiments, the method further includes:
transmitting, by the network device, a first paging message of a current resident cell to a terminal device.

In some embodiments, the first paging message includes at least one of: a terminal device identifier, or a mobile terminated (MT)-small data transmission (SDT) indication.

In some embodiments, the method further includes:
receiving, by the network device, a small data transmission (SDT) transmitted by a terminal device.

In some embodiments, where receiving, by the network device, the small data transmission (SDT) transmitted by the terminal device includes:
receiving, by the network device, first uplink data transmitted by the terminal device using a first uplink resource.

In some embodiments, the first uplink resource includes at least one of the following resource types:
uplink (UL) grant indicated in a random access response (RAR) in a four-step random access procedure;
a physical uplink shared channel (PUSCH) associated with a preamble in a two-step random access procedure; or
a configured grant (CG)-SDT resource.

In some embodiments, the first uplink data at least includes a first RRC message.

In some embodiments, the first RRC message is an RRC resume request message.

FIG. 1 exemplarily illustrates a communication system 100. The communication system includes one network device 110 and two terminal devices 120. In an implementation, the communication system 100 may include multiple network devices 110, and may include other numbers of terminal devices 120 within a coverage range of each network device 110, which is not limited in the embodiments of the present disclosure.

In an implementation, the communication system 100 may also include other network entities such as a Mobility Management Entity (MME), an Access and Mobility Management Function (AMF), and the like, which are not limited in the embodiments of the present disclosure. Herein, the network device may also include an access network device and a core network device. That is, the wireless communication system also includes multiple core networks for communicating with the access network device. The access network device may be an evolutional base station (evolutional node B, abbreviated as eNB or e-NodeB), a macro base station, a micro base station (also referred to as a “small base station”), a pico base station, an access point (AP), a transmission point (TP), a new generation base station (new generation Node B, gNodeB) and the like, in a long-term evolution (LTE) system, a next generation (mobile communication system) (next radio, NR) system or an authorized auxiliary access long-term evolution (LAA-LTE) system.

It should be understood that a device having a communication function in the network or system in the embodiments of the present disclosure may be referred to as a communication device. Taking the communication system shown in FIG. 1 as an example, the communication device may include the network device and the terminal device with the communication function, and the network device and the terminal device may be the specific devices in the embodiments of the present disclosure, which will not be repeated herein; the communication device may also include other devices in the communication system, such as a network controller, a mobility management entity, and other network entities, which are not limited in the embodiments of the present disclosure.

It should be understood that, the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that, “indication” mentioned in the embodiments of the present disclosure may be direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present disclosure, the term “correspondence” may mean that there is a direct correspondence or indirect correspondence between the two, it may also mean that there is an associated relationship between the two, or it may also mean a relationship of indicating and being indicated or a relationship of configuring and being configured, etc.

In order to facilitate understanding of the technical solutions of the embodiments of the present disclosure, related technologies of the embodiments of the present disclosure are described below, and the following related technologies may be, as optional solutions, arbitrarily combined with the technical solutions of the embodiments of the present disclosure, all of which belong to the protection scope of the embodiments of the present disclosure.

### 1.1 MT-EDT

In the LTE, the Early Data Transmission (EDT), that is, the small data transmission, has been introduced. In the procedure, a UE may always remain in an idle state, a suspended state or an inactive state, to complete the transmission of an uplink and/or downlink small data packet. The EDT is divided into a Mobile Originated Early Data Transmission (MO-EDT) and a Mobile Terminated Early Data Transmission (MT-EDT), and the difference thereof lies in whether the EDT is triggered by the terminal or the network.

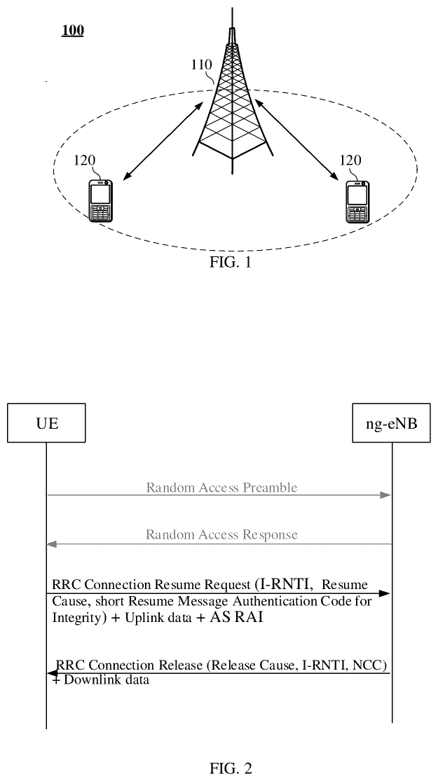

The MO-EDT is an EDT procedure initiated by the terminal, and a maximum TB size allowed to be transmitted by the MO-EDT is included in a system broadcast message by the network. The terminal judges the amount of data to be transmitted, and if it is less than this maximum TB size broadcasted, the UE initiates the EDT procedure. On the contrary, the terminal initiates a normal connection establishment procedure and enters a connected state to transmit data. The MO-EDT is based on a random access procedure, and the terminal transmits uplink data using UL grant acquired in a Random Access Response (RAR). The network allocates a random access resource dedicated to the MO-EDT for the terminal to distinguish whether the current random access procedure is triggered by the MO-EDT, so that the UL grant with a larger size is allocated by the RAR for transmitting data. As illustrated in FIG. 2, an MO-EDT air interface transmission procedure may include: the UE transmits a Random Access Preamble to a base station, such as an ng-eNB (next generation eNodeB, next generation base station). The base station returns a Random Access Response to the UE. The UE transmits a Radio Resource Control (RRC) connection resume request (RRCConnectionResumeRequest) to the base station, which carries an Inactive Radio Network Temporary Identifier (I-RNTI), a resume cause (ResumeCause), and a short integrity authentication code (short Resume Message Authentication Code for Integrity). The UE may also transmit uplink data, access stratum (AS) release assistant information (RAI) and the like to the base station. The base station transmits RRC connection release (RRCConnectionRelease) to the UE, which carries a release cause (releaseCause), an I-RNTI, and an NCC (NextHopChainingCount, Next Hop Chaining Count). The base station may also transmit downlink data to the UE.

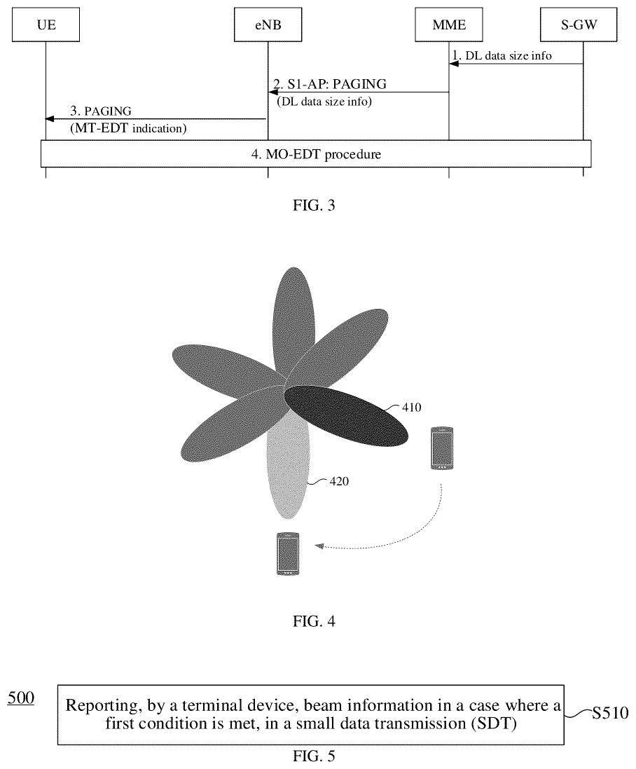

The MT-EDT is an EDT procedure initiated by the network (e.g., exemplarily an MME). When downlink data for a certain terminal arrives at an S-GW, the S-GW informs the MME of data amount information, and indicates, via the MME, the base station to initiate paging to find a target terminal. The target terminal, after receiving a paging message, confirms whether a corresponding terminal identifier and an MT-EDT indication are included. If included, the terminal initiates the MO-EDT procedure to respond to the paging of the network side. As illustrated in FIG. 3, a specific procedure includes: 1. The S-GW transmits downlink data size information (DL data size info) to the MME; 2. The MME transmits Si-AP: PAGING to the eNB, which carries the DL data size info; 3. The eNB transmits paging to the UE, which carries an MT-EDT indication; and 4. The UE initiates the MO-EDT procedure to the network.

The MO-EDT initiated in the MT-EDT procedure differs from normal MO-EDT in that:
the terminal initiates random access by using a legacy Random Access Channel (RACH) resource, i.e., not using a random access resource dedicated to the MO-EDT;
the resume cause (ResumeCause) is the MT-EDT and is used for informing the network of the purpose of currently initiating connection establishment; and
the base station side may further determine whether to indicate the terminal to enter the connected state by a pending data indication transmitted by the core network; where the pending data indication is used for informing the base station whether there is a requirement for a further downlink data transmission.

In addition, in the EDT procedure, only one time of the uplink/downlink data transmission is usually supported.

### 1.2 R17 SDT

In the 5G NR system, RRC states include: an RRC idle state (RRC_IDLE), an RRC inactive state (RRC_INACTIVE) and an RRC connected state (RRC_CONNECTED). Herein, the RRC_INACTIVE state is a new state introduced by the 5G system from the perspective of energy saving. For the UE in the RRC_INACTIVE state, radio bearers and all radio resources will be released. However, the UE side and the base station side reserve UE access context, so as to resume the RRC connection quickly. The network generally maintains UE with infrequent data transmissions in the RRC_INACTIVE state. Before Rel-16, the UE in the RRC_INACTIVE state did not support the data transmission. When Mobile Originated (MO) or Mobile Terminated (MT) data arrives, the UE needs to resume the connection, and release to the INACTIVE state after the data transmission is completed. For the UE with the small data amount and low transmission frequency, this transmission mechanism will lead to unnecessary power consumption and signaling overhead. Therefore, Rel-17 projects to conduct research on the small data transmission (SDT) under the RRC_INACTIVE, and objectives of the project mainly have two directions: an uplink small data transmission based on a random access procedure (two-step/four-step) (hereinafter referred to as RA-SDT) and an uplink small data transmission based on a pre-configured resource (such as CG type1) (hereinafter referred to as CG-SDT). The R17 SDT mainly discusses the MO, that is, the procedure of the SDT triggered by the arrival of uplink data.

For the UE in the RRC_INACTIVE state, the SDT is triggered when the following conditions are met:
the data to be transmitted being from a radio bearer that may trigger the SDT, such as SRB, DRB;
the amount of data to be transmitted being less than an data amount threshold pre-configured by the network;
a downlink Reference Signal Receiving Power (RSRP) measurement result being greater than an RSRP threshold pre-configured by the network;
there being a valid SDT resource, e.g., an RA-SDT resource and/or a CG-SDT resource.

The terminal resumes the radio bearer that may trigger the SDT to support a subsequent uplink and downlink data transmission procedure.

### 1.3 Downlink Beam Management

For the UE in the connected state, the terminal reports a beam measurement result to the network through a Channel Status Indicator (CSI) report. Based on the result, the network performs downlink beam adjustment. The CSI report manners supported in the NR system include:
a periodic CSI report, which is divided into CSI reports based on the Physical Uplink Control Channel (PUCCH) and based on the Physical Uplink Shared Channel (PUSCH), and configured via RRC;
a semi-persistent CSI report, which is divided into a PUSCH report scheduled based on Downlink Control Information (DCI) and a PUCCH report activated based on a Media Access Control (MAC) Control Element (CE);
an aperiodic CSI report.

Different types of CSI report manners correspond to the measurement of different types of CSI-Reference Signal (RS) by the terminal. For example, for the periodic CSI report, the terminal, after receiving the RRC configuration, does not need an additional activation procedure, for starting to measure a periodic CSI-RS signal, and performing the periodic reporting procedure. For the semi-persistent CSI report, if the network does not configure the periodic CSI-RS, it is necessary to activate a semi-persistent CSI-RS first via the MAC CE, and then trigger the reports based on the PUSCH or the PUCCH via the DCI/MAC CE. For the aperiodic CSI report, the measured targets include a periodic CSI-RS, a semi-persistent CSI-RS and an aperiodic CSI-RS.

The beam management includes the MO-SDT, that is, the procedure of the SDT initiated by the terminal. Further, the beam management also includes the MT-SDT, that is, the procedure of the SDT initiated by the network side. According to a Work Item Document (WID), the research objectives of the MT-SDT include:
specifying the support for paging-triggered SDT (MT-SDT) [RAN2, RAN3];
a procedure of the MT-SDT for initial DL data reception and UL/DL data transmissions in RRC_INACTIVE (the procedure of the MT-SDT for initial DL data reception and subsequent UL/DL data transmissions in RRC_INACTIVE).

There may be multiple times of the downlink transmission in the procedure of the MT-SDT triggered by the arrival of downlink data, and the RRC_INACTIVE state does not support the downlink beam management. If the terminal side moves from a coverage range of one beam to a coverage range of another beam (for example, from a range of a beam 410 to a range of a beam 420 in FIG. 4), the network is not aware of the movement of the terminal, resulting in the downlink data not being successfully received. The CSI report configuration configured by the connected state cannot continue to be used in the inactive state for the following reasons that:
for the MT-SDT, the terminal is likely to move to a cell outside a last serving cell, and the CSI report configuration saved in the UE context cannot be used in a new resident cell;
the last serving cell may not give the UE context to the current resident cell, so the last serving cell cannot reconfigure a CSI report parameter via RRC signaling.

FIG. 5 is a schematic flowchart of a communication method 500 according to an embodiment of the present disclosure. Optionally, the method may be applied to the system illustrated in FIG. 1, but not limited thereto. The method includes at least some of the following.

S510, reporting, by a terminal device, beam information in a case where a first condition is met, in a small data transmission (SDT).

Exemplarily, the SDT may also be referred to as an EDT, and may include an MO-EDT initiated by the terminal device and an MT-EDT initiated by a network device, for details please refer to the related description above. If the SDT is initiated by the terminal device, it may be determined whether the first condition is met, based on pre-configured or default information. If the SDT is initiated by the network device, the terminal device may determine whether the first condition is met based on information from the network device. The first condition may include one or more conditions that trigger the beam reporting. For example, in a case where a beam reporting-triggered manner is timer triggering, if a first timer expires, the terminal device may determine that the first condition is met. For another example, in a case where the beam reporting-triggered manner is event triggering, if an event for triggering the beam reporting occurs, the terminal device may determine that the first condition is met.

In an implementation, in S510, reporting the beam information in the case where the first condition is met, includes: reporting beam measurement information or initiating a contention-based random access procedure in a case where a first timer expires.

In the embodiments of the present disclosure, a timing duration of the timer may be set by means of pre-configuration or network configuration. In the case where the first timer expires, the terminal device determines that the first condition is met. In one example, the terminal device may report the beam measurement information to the network device. In another example, the terminal device may initiate the contention-based random access procedure to the network device.

In an implementation, a manner of starting or restarting the first timer includes at least one of:
restarting, by the terminal device, the first timer, after the first timer expires; or
restarting, by the terminal device, the first timer, after the reporting of the beam measurement information is completed.

In an implementation, the first timer is used to control a time interval for periodic beam information reporting.

In the embodiments of the present disclosure, the time interval for the periodic beam information reporting may be controlled by the first timer. When the first timer is started or restarted, the beam measurement information is reported or the contention-based random access procedure is initiated. For example, a timing duration is set, and when the timing of the first timer exceeds the timing duration, the terminal device restarts the first timer, so that the beam measurement information may be reported or the contention-based random access procedure may be initiated periodically according to the timing duration. For another example, when the reporting of the beam measurement information is completed, the terminal device restarts the first timer, so that the beam measurement information may be reported or the contention-based random access procedure may be initiated periodically according to the duration for completing the reporting of the beam measurement information.

In an implementation, a manner of starting or restarting the first timer includes at least one of:
restarting/starting the first timer, if the terminal device receives downlink data transmitted by a network device;
restarting/starting the first timer, if the terminal device initiates a random access procedure and receives a contention-conflict resolution message fed back by a network device; or
restarting the first timer, if the terminal device performs an uplink transmission by using a CG resource and receives feedback from a network device, during the first timer is running.

In an implementation, the first timer is used to monitor a time at which the network device is not in communication with the terminal device.

In the embodiments of the present disclosure, the time at which the network device is not in communication with the terminal device may be monitored by the first timer. For example, the terminal device may restart/start the first timer each time it receives downlink data transmitted by the network device. If the downlink data transmitted by the network device has not been received for a long time, the first timer may be restarted/started, after the first timer expires or the reporting of the beam measurement information is completed. For another example, the terminal device may restart/start the first timer each time it initiates the random access procedure and receives the contention-conflict resolution message fed back by the network device. If the contention-conflict resolution message fed back by the network device has not been received for a long time, the first timer may be restarted/started, after the first timer expires or the reporting of the beam measurement information is completed. For yet another example, the terminal device may restart/start the first timer each time it performs the uplink transmission by using the CG resource and receives the feedback from the network device. If the feedback from the network device has not been received for a long time, the first timer may be restarted/started, after the first timer expires or the reporting of the beam measurement information is completed.

In an implementation, the first timer is stopped in at least one of cases of:
an RRC message being received by the terminal device, and the RRC message indicating to end a procedure of the SDT; or
failure of the SDT occurring at the terminal device.

In the embodiments of the present disclosure, if the RRC message received by the terminal device indicates that it is necessary to end this procedure of the MO-SDT or MT-SDT, the first timer may be stopped. If failure of the MO-SDT or the MT-SDT occurs, it may be unnecessary to continue this procedure of the MO-SDT or MT-SDT and the first timer may be stopped.

In an implementation, the failure of the SDT includes at least one of:
cell reselection occurring in a procedure of the SDT; or
an SDT failure timer expiring.

For example, the cell reselection occurs in the procedure of the MO-SDT or MT-SDT. For another example, the MO-SDT failure timer expires in the procedure of the MO-SDT. For another example, the MT-SDT failure timer expires in the procedure of the MT-SDT.

In an implementation, in S510, reporting the beam information in the case where the first condition is met, includes: reporting beam measurement information or initiating a contention-based random access procedure based on a first event and/or a second event.

In an implementation, the first event includes that a beam with best wireless link quality changes. For example, the wireless link quality corresponding to each beam may be calculated based on the beam measurement result, beams are sorted in order of the quality from good to bad. The top-sorted beam is the beam with the best wireless link quality.

In an implementation, a manner of determining whether the beam with the best wireless link quality changes, includes:
acquiring latest beam measurement results, to determine the beam with the best wireless link quality;
comparing whether the beam with the best wireless link quality is the same as a beam selected under a first operation, where the first operation includes at least one of: a last measurement, a last initiation of a random access procedure, a last transmission using CG; and
determining that the beam with the best wireless link quality changes, in a case where the beam with the best wireless link quality is not the same as the beam selected under the first operation.

For example, among the latest beam measurement results, the beams are sorted as follows in order of the wireless link quality from good to bad: a beam A1, a beam A2, and a beam A3. The beam A1 is a beam with the best wireless link quality. If the beam A1 is different from a beam selected in the last measurement, it means that the beam with the best wireless link quality changes. If the beam A1 is different from a beam selected in the last initiation of the random access procedure, it means that the beam with the best wireless link quality changes. If the beam A1 is different from a beam selected in the last transmission using the CG, it means that the beam with the best wireless link quality changes.

In an implementation, the second event includes at least one of:
wireless link quality of a beam with best wireless link quality being below a first threshold; or
there being wireless link quality of at least one beam above a second threshold.

For example, the first threshold may be a pre-configured threshold. If the wireless link quality of the beam with the best wireless link quality is below the first threshold, it means that the second event occurs, which may trigger the terminal device to report the beam measurement information or initiate the contention-based random access procedure.

For another example, the second threshold may be a pre-configured threshold. If there is the wireless link quality of at least one beam above a second threshold, it means that the second event occurs, which may trigger the terminal device to report the beam measurement information or initiate the contention-based random access procedure.

The first threshold and the second threshold may be the same or different, which is not limited in the embodiments of the present disclosure.

In an implementation, the beam measurement information includes at least one of:
an index of a first beam;
a list of indices of first beams, including indices of first N beams in order of wireless link quality from good to bad;
a list of indices of second beams, including a set of indices of beams meeting a third threshold; or
a beam measurement result corresponding to an index of a beam.

In an implementation, the first beam is a beam with best wireless link quality among all beams.

For example, the terminal device may report the index of the beam with the best wireless link quality. For another example, the terminal device may report the list of indices of first beams, composed of indices of first N beams in order of wireless link quality from good to bad.

For yet another example, the third threshold may be a threshold of the beam measurement results. The beam measurement results may include at least one of RSRP, Reference Signal Receiving Quality (RSRQ), Signal to Interference plus Noise Ratio (SINR), and the like. For different types of the beam measurement results, different third thresholds may be set. The terminal device may report the list of indices of second beams, composed of the set of indexes of beams with beam measurement results above the third threshold.

For another example, the terminal device may report the beam measurement result corresponding to the index of the first beam. The terminal device may also report the beam measurement results corresponding to one or more indices of beams in the list of indices of first beams. The terminal device may also report the beam measurement results corresponding to one or more indices of beams in the list of indices of second beams.

In an implementation, an evaluation metric of the wireless link quality includes at least one of the following beam measurement results: reference signal receiving power (RSRP), reference signal receiving quality (RSRQ), or signal to interference plus noise ratio (SINR).

In an implementation, the N is carried in a broadcast message and/or a first feedback message. For example, the terminal device receives the broadcast message from the network device, and a value of the N carried in the broadcast message is 5, then the list of indices of first beams reported by the terminal device may include indices of first 5 beams in order of wireless link quality from good to bad. For another example, the terminal device receives the first feedback message for first uplink data, from the network device, and a value of the N carried in the first feedback message is 3, then the list of indices of first beams reported by the terminal device may include indices of first 3 beams in order of wireless link quality from good to bad.

In an implementation, the third threshold is carried in a broadcast message and/or a first feedback message. For example, the terminal device receives the broadcast message from the network device, and a value of the N carried in the broadcast message is 5, then the list of indices of first beams reported by the terminal device may include indices of first 5 beams in order of wireless link quality from good to bad. For another example, the terminal device receives the first feedback message for first uplink data, from the network device, and a value of the N carried in the first feedback message is 3, the list of indices of first beams reported by the terminal device may include indices of first 3 beams in order of wireless link quality from good to bad.

In an implementation, the beam measurement information is carried in a first MAC CE. For example, the terminal device transmits the first MAC CE to the network device, and the first MAC CE carries the beam measurement information.

In an implementation, the method also includes: triggering, by the terminal device, a scheduling request (SR) based on the first MAC CE in a case of no uplink transmission resource, to trigger a random access procedure to acquire an uplink transmission resource.

In an implementation, the beam measurement information is reported via a physical random access channel (PRACH) resource of a transmission preamble of the contention-based random access procedure.

In an implementation, the terminal device is in a radio resource control inactive (RRC_INACTIVE) state or a radio resource control idle (RRC_IDLE) state.

In an implementation, a reference signal corresponding to a beam is an SSB and/or a CSI-RS transmitted in a broadcast message. For example, the network device transmits the SSB and/or the CSI-RS via the broadcast message. The terminal device, after receiving the broadcast message, may use the SSB and/or the CSI-RS in the broadcast message as the reference signal for the beam measurement.

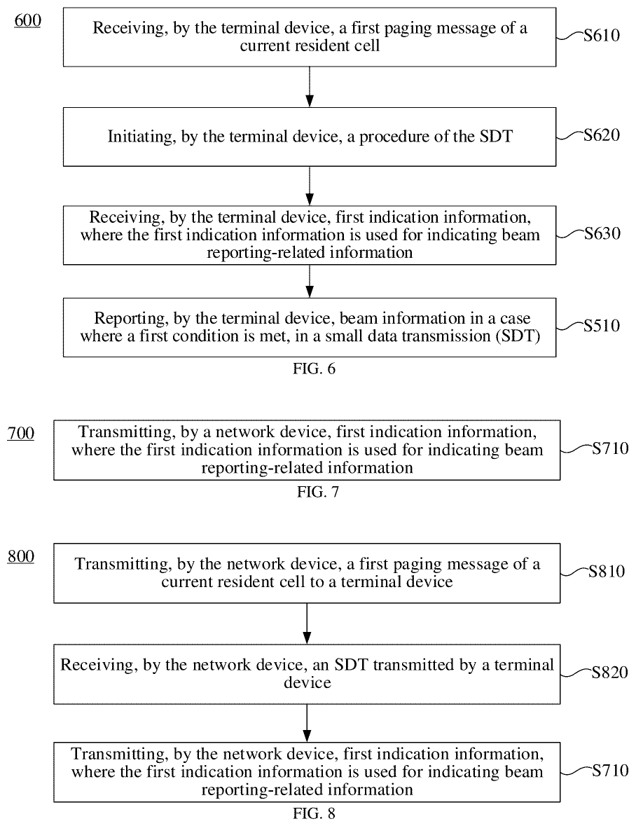

In an implementation, as illustrated in FIG. 6, the method also includes: S610, receiving, by the terminal device, a first paging message of a current resident cell. For example, the UE in the RRC_INACTIVE state or the RRC_IDLE state receives the first paging message transmitted by the current resident cell.

In an implementation, the first paging message includes at least one of: a terminal device identifier, or a mobile terminated (MT)-small data transmission (SDT) indication. For example, the terminal device identifier may include I-RNTI. For example, the MT-SDT indication may indicate that the terminal device is in the procedure of the MT-SDT currently. Or, the first paging message may include an SDT indication, the SDT indication being a first value means that the terminal device is in the procedure of the MT-SDT currently, and the SDT indication being a second value means that the terminal device is in the procedure of the MO-SDT currently.

In an implementation, the method also includes: S620, initiating, by the terminal device, a procedure of the SDT.

In an implementation, the procedure of the small data transmission includes: transmitting first uplink data to the network device by using a first uplink resource. For example, the terminal device, after receiving the first paging message, initiates the procedure of the SDT and transmits the first uplink data to the network device by using the first uplink resource.

In an implementation, the first uplink resource includes at least one of the following resource types:
uplink (UL) grant indicated in a random access response (RAR) in a four-step random access procedure;
a physical uplink shared channel (PUSCH) associated with a preamble in a two-step random access procedure; or
a configured grant (CG)-SDT resource.

In an implementation, the first uplink data at least includes a first RRC message.

In an implementation, the first RRC message is an RRC resume request (RRCResumeRequest) message.

In an implementation, the method also includes: S630, receiving, by the terminal device, first indication information, where the first indication information is used for indicating beam reporting-related information. For example, the terminal device may receive the first indication information from the network device, and determine whether the first condition is met based on the beam reporting-related information indicated by the first indication information. Then, the terminal device may perform S510, the reporting of the beam information in the case where the first condition is met.

In an implementation, the beam reporting-related information includes at least one of:
whether to start a beam reporting procedure; or
a beam reporting-triggered manner.

In the embodiments of the present disclosure, one or more bits may indicate whether to start the beam reporting procedure. For example, if a value of the bit indicating whether to start the beam reporting procedure is 0, it means that the beam reporting procedure is not started; and if the value is 1, it means that the beam reporting procedure is started.

For another example, the beam reporting-triggered manner may indicate that the beam reporting-triggered manner of the terminal device is adopted. The beam reporting-triggered manner may include a timer triggering and/or an event triggering. The timer triggering and/or the event triggering may be combined, for example, both a timer triggering condition and an event triggering condition are met, and then the terminal device is triggered to perform the beam reporting.

In the embodiments of the present disclosure, determining whether the first condition is met based on the beam reporting-related information may include multiple cases, and the examples are shown as follows.

For example: if in the beam reporting-related information, whether to start the beam reporting procedure indicates not to start the beam reporting procedure, the first condition is not met.

For another example, if in the beam reporting-related information, whether to start the beam reporting procedure indicates to start the beam reporting procedure, then the judgment is performed according to the beam reporting-triggered manner. If the beam reporting-triggered manner is the timer triggering, it may be further judged whether the first timer is restarted due to expiring or restarted due to other reasons. If the first timer is restarted due to expiring or restarted due to other reasons, the first condition is met. If the beam reporting-triggered manner is the event triggering, it may be further judged whether the event used for triggering occurs. If it occurs, the first condition is met.

In an implementation, the first indication information is carried in a broadcast message and/or a first feedback message. For example, the terminal device may receive the broadcast message from the network device, and the first indication information is carried in the broadcast message. For another example, the terminal device, after transmitting the first uplink data to the network device, receives the first feedback message from the network device, and the first indication information is carried in the first feedback message.

In an implementation, the first feedback message includes at least one of: DCI, an MAC CE, or an RRC message.

In an implementation, the first feedback message includes at least one of:
a contention-collision resolution successful identifier; or
second indication information used for indicating to the terminal device that first uplink data is successfully received.

In an implementation, the second indication information includes at least one of: downlink data, an uplink new transmission schedule, or a downlink MAC CE.

In an implementation, the downlink MAC CE is a timing advance command (TAC) MAC CE.

In an implementation, the beam reporting-triggered manner includes timer triggering, and the timer triggering is used for indicating the terminal device to report beam measurement information or initiate a contention-based random access procedure in a case where a first timer expires. Specific examples of the timer triggering may refer to the related description about the first timer mentioned above, which will not be repeated here.

In an implementation, the beam reporting-triggered manner includes event triggering, and the event triggering is used for indicating the terminal device to report beam measurement information or initiate a contention-based random access procedure based on a first event and/or a second event. Specific examples of the event triggering may refer to the related description about the first event and/or the second event mentioned above, which will not be repeated here.

In the embodiments of the present disclosure, the beam reporting may be triggered based on a certain condition, such as the timer or the event, thereby improving the communication reliability. For example, it may help the network to adjust downlink transmitting/uplink receiving beams timely, thereby improving the reliability of the downlink communication.

FIG. 7 is a schematic flowchart of a communication method 700 according to another embodiment of the present disclosure. Optionally, the method may be applied to the system illustrated in FIG. 1, but not limited thereto. This embodiment has the same meaning as the same description in the method 500, which may refer to the related description in the method 500 mentioned above, and will not be repeated here for the sake of brevity. The method 700 includes at least some of the following content.

S710, transmitting, by a network device, first indication information, where the first indication information is used for indicating beam reporting-related information.

In an implementation, the beam reporting-related information includes at least one of:
whether to start a beam reporting procedure; or
a beam reporting-triggered manner.

In an implementation, the first indication information is carried in a broadcast message and/or a first feedback message.

In an implementation, the first feedback message includes at least one of: downlink control information (DCI), a media access control (MAC) control element (CE), or an RRC message.

In an implementation, the first feedback message includes at least one of:
a contention-collision resolution successful identifier; or
second indication information used for indicating to the terminal device that first uplink data is successfully received.

In an implementation, the second indication information includes at least one of: downlink data, an uplink new transmission schedule, or a downlink MAC CE.

In an implementation, the downlink MAC CE is a timing advance command (TAC) MAC CE.

In an implementation, the beam reporting-triggered manner includes timer triggering, and the timer triggering is used for indicating the terminal device to report beam measurement information or initiate a contention-based random access procedure in a case where a first timer expires.

In an implementation, the beam reporting-triggered manner includes event triggering, and the event triggering is used for indicating the terminal device to report beam measurement information or initiate a contention-based random access procedure based on a first event and/or a second event.

In an implementation, the first event includes that a beam with best wireless link quality changes.

In an implementation, the second event includes at least one of:
wireless link quality of a beam with best wireless link quality being below a first threshold; or
there being wireless link quality of at least one beam above a second threshold.

In an implementation, the beam measurement information includes at least one of:
an index of a first beam;
a list of indices of first beams, including indices of first N beams in order of wireless link quality from good to bad;
a list of indices of second beams, including a set of indices of beams meeting a third threshold; or
a beam measurement result corresponding to an index of a beam.

In an implementation, the first beam is a beam with best wireless link quality among all beams.

In an implementation, an evaluation metric of the wireless link quality includes at least one of the following beam measurement results: reference signal receiving power (RSRP), reference signal receiving quality (RSRQ), or signal to interference plus noise ratio (SINR).

In an implementation, the beam measurement information is carried in a first MAC CE.

In an implementation, the beam measurement information is reported via a PRACH resource of a transmission preamble of the contention-based random access procedure.

In an implementation, the terminal device is in a radio resource control inactive (RRC_INACTIVE) state or a radio resource control idle (RRC_IDLE) state.

In an implementation, a reference signal corresponding to a beam is an SSB and/or a CSI-RS transmitted in a broadcast message.

In an implementation, as illustrated in FIG. 8, the method also includes:
S810, transmitting, by the network device, a first paging message of a current resident cell to a terminal device.

In an implementation, the first paging message includes at least one of: a terminal device identifier, or an MT-SDT indication.

In an implementation, the method also includes:
S820, receiving, by the network device, an SDT transmitted by a terminal device.

In an implementation, receiving, by the network device, the SDT transmitted by the terminal device, includes:
receiving, by the network device, first uplink data transmitted by the terminal device using a first uplink resource.

In the embodiments of the present disclosure, the network device, after receiving the first uplink data, may transmit the first feedback information to the terminal device, and the first indication information is carried in the first feedback information. Then, the network device may receive the beam information reported by the terminal device based on the first indication information. The specific reporting procedure may refer to the related description of the methods 500 and 600 mentioned above, and will not be repeated here.

In an implementation, the first uplink resource includes at least one of the following resource types:
uplink (UL) grant indicated in a random access response (RAR) in a four-step random access procedure;
a physical uplink shared channel (PUSCH) associated with a preamble in a two-step random access procedure; or
a configured grant (CG)-SDT resource.

In an implementation, the first uplink data at least includes a first RRC message.

In an implementation, the first RRC message is an RRC resume request message.

Specific examples of the methods 700 and 800 performed by the network device of this embodiment may refer to the related description about the network device in the methods 500 and 600 mentioned above, and will not be repeated here for the sake of brevity.

The communication method provided by the embodiments of the present disclosure is a beam reporting method in the procedure of the MT-SDT. The method may include a beam reporting procedure in the procedure of the MT-SDT, and may exemplarily include at least one of:
(1) a beam reporting procedure based on a timer; where the timer may be used to control periodicity or to monitor a time at which the terminal is not in communication with the network;
(2) a beam reporting procedure triggered based on an event; or
(3) a beam reporting manner being able to include: initiating a random access procedure (which may be abbreviated as RACH), and/or carrying one or more beam measurement results via the first MAC CE.

### Example One: A Beam Information Reporting Procedure Based on a Timer

1. The UE in the RRC_INACTIVE state or the RRC_IDLE state receives the first paging message transmitted by the current resident cell, where the first paging message at least includes: the terminal identifier, such as Inactive-Radio Network Temporary Identifier (I-RNTI); and the MT-SDT indication.

2. The terminal, after receiving the first paging message, initiates the procedure of the small data transmission. In the procedure of the small data transmission, the terminal transmits the first uplink data to the network by using the first uplink resource. Herein, the first uplink resource includes one of the following resource types: the UL grant indicated in the Random Access Response (RAR) in the 4-step random access procedure; the Physical Uplink Shared Channel (PUSCH) associated with the preamble in the 2-step random access procedure; and the Configured Grant (CG)-SDT resource. The first uplink data at least includes the first RRC message, such as, the RRC resume request (RRCResumeRequest).

3. The terminal receives the first feedback message after transmitting the first uplink data, and the first feedback message may be the DCI/MAC CE/RRC message. The first feedback message may include the first indication information for indicating the beam reporting-related information. The beam reporting-related information includes at least one of: whether to start a beam reporting procedure; or a beam reporting-triggered manner.

The first feedback message may also at least include one or more of:
a) a contention-collision resolution successful identifier; or
b) a second indication information for indicating to the terminal device that the first uplink data is successfully received, for example, downlink data, an uplink new transmission schedule, and a downlink MAC CE. Herein, the downlink MAC CE may be a TAC MAC CE.

4. The terminal, after receiving the first feedback message, starts the first timer. The first timer expires, and then the behavior of the terminal includes at least one of the following schemes.

Scheme 1: the terminal reports the beam measurement information to the network, and the beam measurement information may be one of:
a) an index of a first beam, where the first beam is a beam with a best wireless link quality among all beams, and metrics for evaluating the wireless link quality include one or more of RSRP, RSRQ and SINR; or
b) a list of indices of first beams, where the list of indices of first beams includes indices of first N beams in order of wireless link quality from good to bad, N may be a predefined value or included in the broadcast message or included in the first feedback message; or
c) a list of indices of second beams, where the list of indices of second beams is a set of indices of beams meeting a certain threshold (the third threshold), and the threshold is configured by the broadcast message or the first feedback message; if there is no beam meeting the threshold, the terminal reports the beam with the best wireless link quality, or the terminal reports third indication information for informing the network that there is no beam meeting the threshold currently; or
d) in addition to the above two types of indices of beams, the beam measurement information may also include a beam measurement result corresponding to an index of a beam, such as RSRP, RSRQ, SINR and so on.

The beam measurement information may be included in the first MAC CE, and when there is no uplink transmission resource, the first MAC CE triggers the SR, and then triggers the RACH to acquire the uplink transmission resource.

The reference signal corresponding to the beam is the SSB and/or the CSI-RS transmitted in the broadcast message.

Scheme 2: the terminal initiates a contention-based random access procedure.

5. The terminal starting/restarting the first timer, includes the following schemes.

Scheme 1: a periodic beam information reporting is performed, and the first timer is used to control the time interval for the periodic reporting. A specific manner of starting/restarting the first timer may include at least one of:
a) restarting the first timer, after the first timer expires; or
b) restarting the first timer, after the reporting of the beam measurement information is completed.

Scheme 2: the first timer is used to monitor the time at which the network is not in communication with the terminal device. A specific manner of starting/restarting the first timer may include at least one of:
a) restarting/starting the first timer, if the terminal receives the downlink data transmitted by the network;
b) restarting/starting the first timer, if the terminal initiates the random access procedure (RACH) and receives the contention-conflict resolution message fed back by the network; or
c) restarting the first timer, if the terminal performs the uplink transmission by using the CG resource and receives the feedback from the network side, during the first timer is running.

6. For the terminal stopping the first timer, a specific manner may include at least one of:
a) receiving the RRC message, where the RRC message indicates to end the procedure of the MT-SDT; or
b) failure of the SDT occurring, for example, the cell reselection occurring in the procedure of the SDT, or the SDT failure timer expiring.

In point 4 of this example, the terminal may need to start, restart or stop the timer in the case of reporting the beam measurement information or initiating the random access procedure. Cases where the timer needs to be started or restarted may refer to the related description in point 5. Cases where the timer needs to be stopped may refer to the related description in point 6.

### Example Two: The Beam Reporting Triggered Based on an Event

1. The UE in the RRC_INACTIVE state receives the first paging message transmitted by the current resident cell, where the first paging message at least includes: the terminal identifier, such as an I-RNTI; and the MT-SDT indication.

2. The terminal, after receiving the first paging message, initiates the procedure of the small data transmission. In the procedure of the small data transmission, the terminal transmits the first uplink data to the network by using the first uplink resource. Herein, the first uplink resource includes one of the following resource types: the UL grant in the RAR in the 4-step random access procedure, the PUSCH associated with the preamble in the 2-step random access procedure and the CG-SDT resource. The first uplink data at least includes the first RRC message, such as the RRC resume request (RRCResumeRequest).

3. The terminal receives the first feedback message after transmitting the first uplink data, and the first feedback message may be the DCI, MAC CE or RRC message. The first feedback message may include the first indication information for indicating the beam reporting-related information. The beam reporting-related information includes at least one of: whether to start a beam reporting procedure; or a beam reporting-triggered manner.

The first feedback message may also at least include one or more of:
a) a contention-collision resolution successful identifier; or
b) a second indication information for indicating to the terminal device that the first uplink data is successfully received, for example, downlink data, an uplink new transmission schedule, and a downlink MAC CE. Herein, the downlink MAC CE may be a TAC MAC CE.

4. After the terminal receives the first feedback message, the terminal initiates the random access procedure to the network or reports the beam measurement information via the first MAC CE, in a case where one or more of the following events occur. The details of initiating the random access procedure or reporting the beam measurement information may refer to the related description of scheme 1 and scheme 2 in point 4 of example one.

In this example, the event used to trigger the reporting may include at least one of:
a) event one: where the beam with the best wireless link quality changes, for example, the beam selected in the last initiation of the random access procedure by the terminal, and/or in the transmission of data using the CG resource, is A; and the beam with the best wireless link quality becomes B according to the latest measurement results;
b) event two: where the beam with the best wireless link quality is below a certain pre-configured threshold (the first threshold), and/or there is at least one beam with a wireless link above a certain pre-configured threshold (the second threshold). Herein, the manner of determining whether the beam with the best wireless link quality changes, may include: acquiring the latest beam measurement results, to determine the beam with the best wireless link quality; comparing whether the beam with the best wireless link quality is the same as a beam selected under a last measurement, a last initiation of the random access procedure, or a last transmission using the CG resource. If they are not the same, it is determined that the beam with the best wireless link quality changes.

For the schemes in example one and/or example two mentioned above, the network may indicate the following information to the terminal via the broadcast message or the first feedback message: a) whether to start the beam reporting procedure; and/or b) using which beam reporting-triggered manner.

In addition, the first MAC CE in the above examples may be a Beam Failure Recovery (BFR) MAC CE.

According to the schemes provided in the embodiments of the present disclosure, the terminal may trigger the beam reporting based on the timer or the event, which helps the network to adjust the downlink transmitting/uplink receiving beams timely, thereby improving the reliability of the downlink communication.

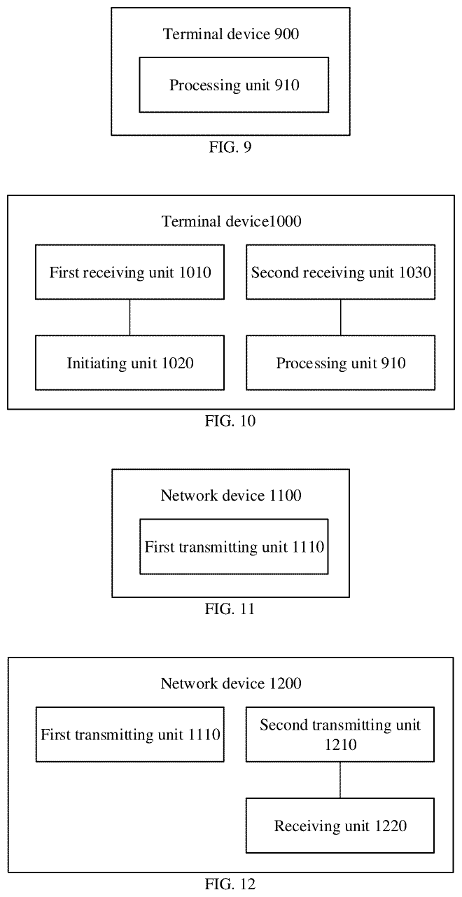

FIG. 9 is a schematic block diagram of a terminal device 900 according to an embodiment of the present disclosure. The terminal device 900 may include:
a processing unit 910, configured to report beam information in a case where a first condition is met, in a small data transmission (SDT).

In an implementation, the processing unit 910 is configured to report beam measurement information or initiate a contention-based random access procedure in a case where a first timer expires.

In an implementation, the processing unit 910 is further configured to control the first timer to start or restart in at least one of manners of:
restarting the first timer after the first timer expires; or
restarting the first timer after the reporting of the beam measurement information is completed.

In an implementation, the first timer is used to control a time interval for periodic beam information reporting.

In an implementation, the processing unit 910 is further configured to control the first timer to start or restart in at least one of manners of:
restarting/starting the first timer, if downlink data transmitted by a network device is received;
restarting/starting the first timer, if a random access procedure is initiated and a contention-conflict resolution message fed back by a network device is received; or
restarting the first timer, if an uplink transmission is performed by using a CG resource and feedback from a network device is received, during the first timer is running.

In an implementation, the first timer is used to monitor a time at which the network device is not in communication with the terminal device.

In an implementation, the processing unit 910 is further configured to control the first timer to stop in at least one of cases of:
an RRC message being received by the terminal device, and the RRC message indicating to end a procedure of the SDT; or
failure of the SDT occurring at the terminal device.

In an implementation, the failure of the SDT includes at least one of:
cell reselection occurring in a procedure of the SDT; or
an SDT failure timer expiring.

In an implementation, the processing unit 910 is further configured to report beam measurement information or initiate a contention-based random access procedure based on a first event and/or a second event.

In an implementation, the first event includes that a beam with best wireless link quality changes.

In an implementation, a manner of the processing unit to determine whether the beam with the best wireless link quality changes, includes:
acquiring latest beam measurement results, to determine the beam with the best wireless link quality;
comparing whether the beam with the best wireless link quality is the same as a beam selected under a first operation, where the first operation includes at least one of: a last measurement, a last initiation of a random access procedure, a last transmission using CG; and
determining that the beam with the best wireless link quality changes, in a case where the beam with the best wireless link quality is not the same as the beam selected under the first operation.

In an implementation, the second event includes at least one of:
wireless link quality of a beam with best wireless link quality being below a first threshold; or
there being wireless link quality of at least one beam above a second threshold.

In an implementation, the beam measurement information includes at least one of:
an index of a first beam;
a list of indices of first beams, including indices of first N beams in order of wireless link quality from good to bad;
a list of indices of second beams, including a set of indices of beams meeting a third threshold; or
a beam measurement result corresponding to an index of a beam.

In an implementation, the first beam is a beam with best wireless link quality among all beams.

In an implementation, an evaluation metric of the wireless link quality includes at least one of the following beam measurement results: reference signal receiving power (RSRP), reference signal receiving quality (RSRQ), or signal to interference plus noise ratio (SINR).

In an implementation, the the N is carried in a broadcast message and/or a first feedback message; and/or
the third threshold is carried in a broadcast message and/or a first feedback message.

In an implementation, the beam measurement information is carried in a first MAC CE.

In an implementation, the device further includes an acquiring unit, configured to trigger a scheduling request (SR) based on the first MAC CE in a case of no uplink transmission resource, to trigger a random access procedure to acquire an uplink transmission resource.

In an implementation, the beam measurement information is reported via a physical random access channel (PRACH) resource of a transmission preamble of the contention-based random access procedure.

In an implementation, the terminal device is in a radio resource control inactive (RRC_INACTIVE) state or a radio resource control idle (RRC_IDLE) state.

In an implementation, a reference signal corresponding to a beam is an SSB and/or a CSI-RS transmitted in a broadcast message.

In an implementation, as illustrated in FIG. 10, the terminal device 1000 further includes:
a first receiving unit 1010, configured to receive a first paging message of a current resident cell by the terminal device.

In an implementation, the first paging message includes at least one of: a terminal device identifier, or a mobile terminated (MT)-small data transmission (SDT) indication.

In an implementation, the terminal device 1000 further includes an initiating unit 1020, configured to initiate a procedure of the small data transmission (SDT).

In an implementation, the initiating unit being configured to initiate the procedure of the small data transmission, includes: transmitting first uplink data to a network device by using a first uplink resource.

In an implementation, the first uplink resource includes at least one of the following resource types:
uplink (UL) grant indicated in a random access response (RAR) in a four-step random access procedure;
a physical uplink shared channel (PUSCH) associated with a preamble in a two-step random access procedure; or
a configured grant (CG)-SDT resource.

In an implementation, the first uplink data at least includes a first RRC message.

In an implementation, the first RRC message is an RRC resume request message.

In an implementation, the terminal device 1000 further includes a second receiving unit 1030, configured to receive first indication information by the terminal device, where the first indication information is used for indicating beam reporting-related information.

In an implementation, the beam reporting-related information includes at least one of:
whether to start a beam reporting procedure; or
a beam reporting-triggered manner.

In an implementation, the first indication information is carried in a broadcast message and/or a first feedback message.

In an implementation, the first feedback message includes at least one of: downlink control information (DCI), a media access control (MAC) control element (CE), and an RRC message.

In an implementation, the first feedback message includes at least one of:
a contention-collision resolution successful identifier; or
second indication information used for indicating to the terminal device that first uplink data is successfully received.

In an implementation, the second indication information includes at least one of: downlink data, an uplink new transmission schedule, or a downlink MAC CE.

In an implementation, the downlink MAC CE is a timing advance command (TAC) MAC CE.

In an implementation, the beam reporting-triggered manner includes timer triggering, and the timer triggering is used for indicating the terminal device to report beam measurement information or initiate a contention-based random access procedure in a case where a first timer expires.

In an implementation, the beam reporting-triggered manner includes event triggering, and the event triggering is used for indicating the terminal device to report beam measurement information or initiate a contention-based random access procedure based on a first event and/or a second event.

The terminal devices 900 and 1000 of the embodiments of the present disclosure can implement the corresponding functions of the terminal device in the embodiments of the methods 500 and 600 mentioned above. The procedures, functions, implementations and beneficial effects corresponding to various modules (submodules, units, components, and the like) in the terminal device may refer to the corresponding description in the method embodiments mentioned above, and will not be repeated here. It needs to be noted that the functions described with respect to various modules (submodules, units or components, and the like) in the terminal device of the embodiments of the present disclosure may be implemented by different modules (submodules, units or components, and the like), or may also be implemented by a same module (submodule, unit or component and the like).

FIG. 11 is a schematic block diagram of a network device 1100 according to an embodiment of the present disclosure. The network device 1100 may include:
a first transmitting unit 1110, configured to transmit first indication information, where the first indication information is used for indicating beam reporting-related information.

In an implementation, the beam reporting-related information includes at least one of:
whether to start a beam reporting procedure; or
a beam reporting-triggered manner.

In an implementation, the first indication information is carried in a broadcast message and/or a first feedback message.

In an implementation, the first feedback message includes at least one of: downlink control information (DCI), a media access control (MAC) control element (CE), or an RRC message.

In an implementation, the first feedback message includes at least one of:
a contention-collision resolution successful identifier; or
second indication information used for indicating to the terminal device that first uplink data is successfully received.

In an implementation, the second indication information includes at least one of: downlink data, an uplink new transmission schedule, or a downlink MAC CE.

In an implementation, the downlink MAC CE is a timing advance command (TAC) MAC CE.

In an implementation, the beam reporting-triggered manner includes timer triggering, and the timer triggering is used for indicating the terminal device to report beam measurement information or initiate a contention-based random access procedure in a case where a first timer expires.

In an implementation, the beam reporting-triggered manner includes event triggering, and the event triggering is used for indicating the terminal device to report beam measurement information or initiate a contention-based random access procedure based on a first event and/or a second event.

In an implementation, the first event includes that a beam with best wireless link quality changes.

In an implementation, the second event includes at least one of:
wireless link quality of a beam with best wireless link quality being below a first threshold; or
there being wireless link quality of at least one beam above a second threshold.

In an implementation, the beam measurement information includes at least one of:
an index of a first beam;
a list of indices of first beams, including indices of first N beams in order of wireless link quality from good to bad;
a list of indices of second beams, including a set of indices of beams meeting a third threshold; or
a beam measurement result corresponding to an index of a beam.

In an implementation, the first beam is a beam with best wireless link quality among all beams.

In an implementation, an evaluation metric of the wireless link quality includes at least one of the following beam measurement results: reference signal receiving power (RSRP), reference signal receiving quality (RSRQ), or signal to interference plus noise ratio (SINR).

In an implementation, the beam measurement information is carried in a first MAC CE.

In an implementation, the beam measurement information is reported via a PRACH resource of a transmission preamble of the contention-based random access procedure.

In an implementation, the terminal device is in a radio resource control inactive (RRC_INACTIVE) state or a radio resource control idle (RRC_IDLE) state.

In an implementation, a reference signal corresponding to a beam is an SSB and/or a CSI-RS transmitted in a broadcast message.

In an implementation, as illustrated in FIG. 12, the network device 1200 further includes a second transmitting unit 1210, configured to transmit a first paging message of a current resident cell to a terminal device.

In an implementation, the first paging message includes at least one of: a terminal device identifier, or a mobile terminated (MT)-small data transmission (SDT) indication.

In an implementation, the network device 1200 further includes a receiving unit 1220, configured to receive SDT transmitted by a terminal device.

In an implementation, the receiving unit 1220 is configured to receive first uplink data transmitted by the terminal device using a first uplink resource.

In an implementation, the first uplink resource includes at least one of the following resource types:
uplink (UL) grant indicated in a random access response (RAR) in a four-step random access procedure;
a physical uplink shared channel (PUSCH) associated with a preamble in a two-step random access procedure; or
a configured grant (CG)-SDT resource.

In an implementation, the first uplink data at least includes a first RRC message.

In an implementation, the first RRC message is an RRC resume request message.

In an implementation, the receiving unit 1220 is further configured to receive the beam information reported by the terminal device.

The network devices 1100 and 1200 of the embodiments of the present disclosure can implement the corresponding functions of the network device in the embodiments of the methods 700 and 800 mentioned above. The procedures, functions, implementations and beneficial effects corresponding to various modules (submodules, units, components, and the like) in the network device may refer to the corresponding description in the method embodiments mentioned above, and will not be repeated here. It needs to be noted that the functions described with respect to various modules (submodules, units or components, and the like) in the network device of the embodiments of the present disclosure may be implemented by different modules (submodules, units or components, and the like), or may also be implemented by a same module (submodule, unit or component and the like).

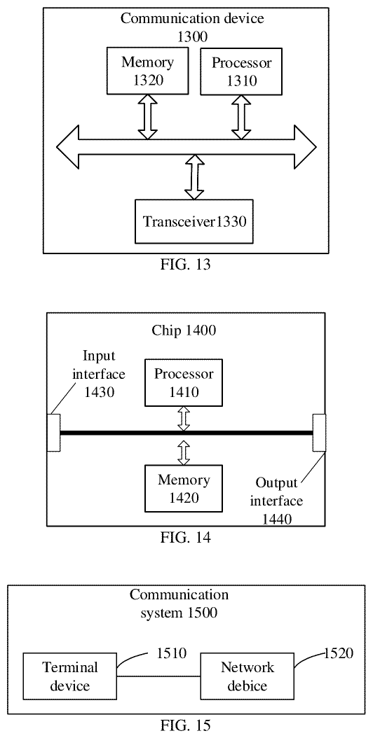

FIG. 13 is a schematic structural diagram of a communication device 1300 according to the embodiments of the present disclosure. The communication device 1300 includes a processor 1310, and processor 1310 may invoke and execute a computer program from a memory to cause the communication device 1300 to implement the method in the embodiments of the present disclosure.

In an implementation, the communication device 1300 may also include a memory 1320. Herein, the processor 1310 may invoke and execute a computer program from the memory 1320 to cause the communication device 1300 to implement the method in the embodiments of the present disclosure.

The memory 1320 may be a separate device independent from the processor 1310 or may also be integrated into the processor 1310.

In an implementation, the communication device 1300 may also include a transceiver 1330, and the processor 1310 may control the transceiver 1330 to communicate with other devices, and exemplarily, to be able to transmit information or data to other devices, or receive information or data transmitted by the other devices.

Herein, the transceiver 1330 may include a transmitter and a receiver. The transceiver 1330 may further include antennas, and the number of the antennas may be one or more.

In an implementation, the communication device 1300 may be the network device of the embodiments of the present disclosure, and the communication device 1300 may implement the corresponding procedures implemented by the network device in various methods of the embodiments of the present disclosure, which will not be repeated here for the sake of brevity.

In an implementation, the communication device 1300 may be the terminal device of the embodiments of the present disclosure, and the communication device 1300 may implement the corresponding procedures implemented by the terminal device in various methods of the embodiments of the present disclosure, which will not be repeated here for the sake of brevity.

FIG. 14 is a schematic block diagram of a chip 1400 according to an embodiment of the present disclosure. The chip 1400 includes a processor 1410, the processor 1410 may invoke and execute a computer program from a memory to implement the method in the embodiments of the present disclosure.

In an implementation, chip 1400 may also include memory 1420. Herein, the processor 1410 may invoke and execute a computer program from a memory 1420 to implement the method performed by the terminal device or the network device in the embodiments of the present disclosure.

Herein, the memory 1420 may be a separate device independent from the processor 1410, or may also be integrated into the processor 1410.

In an implementation, the chip 1400 may further include an input interface 1430. Herein, the processor 1410 may control the input interface 1430 to communicate with other devices or chips, and exemplarily, to be able to acquire information or data transmitted by other devices or chips.

In an implementation, the chip 1400 may further include an output interface 1440. Herein, the processor 1410 may control the output interface 1440 to communicate with other devices or chips, and exemplarily, to be able to output information or data to other devices or chips.

In an implementation, the chip may be applied to the network device in the embodiments of the present disclosure, and the chip may implement the corresponding procedure implemented by the network device in the various methods of the embodiments of the present disclosure, which will not be repeated here for the sake of brevity.

In an implementation, the chip may be applied to the terminal device in the embodiments of the present disclosure, and the chip may implement the corresponding procedure implemented by the terminal device in the various methods of the embodiments of the present disclosure, which will not be repeated here for the sake of brevity.

The chips applied to the network device and the terminal device may be the same chip or different chips.

It should be understood that, the chip mentioned in the embodiments of the present disclosure may also be referred to as a system on chip, a system chip, a chip system or a system-on-chip chip, etc.

The processor mentioned above may be a general-purpose processor, a digital signal processor (DSPS), a field programmable gate array (FPGA), an application specific integrated circuit (ASIC), or other programmable logic devices, transistor logic devices or discrete hardware components. Herein, the general-purpose processor mentioned above may be a microprocessor or may also be any conventional processor or the like.

The memory mentioned above may be a volatile memory or a non-volatile memory, or may include both the volatile memory and the non-volatile memory. Herein, the non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM) or flash memory. The volatile memory may be a random access memory (RAM).

It should be understood that the above memory is exemplary but not limited illustration. For example, the memory in the embodiments of the present disclosure may also be a static random access memory (static RAM, SRAM), a dynamic random access memory (dynamic RAM, DRAM), a synchronous dynamic random access memory (synchronous DRAM, SDRAM)), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct Rambus random access memory (Direct Rambus RAM, DR RAM), etc. That is, the memory in the embodiments of the present disclosure is intended to include, but not limited to, these and any other suitable types of memories.

FIG. 15 is a schematic block diagram of a communication system 1500 according to the embodiments of the present disclosure. The communication system 1500 includes a terminal device 1510 and a network device 1520. The network device 1520 is configured to transmit first indication information, where the first indication information is used for indicating beam reporting-related information. The terminal device 1510 is configured to report beam information in a case where a first condition is met, in a small data transmission (SDT). In one embodiment, the terminal device 1510 may determine whether the first condition is met based on the beam reporting-related information indicated by the first indication information. Herein, the terminal device 1510 may be used to implement the corresponding functions implemented by the terminal device in the method mentioned above, and the network device 1520 may be used to implement the corresponding functions implemented by the network device in the method mentioned above. For the sake of brevity, they will not be repeated here.

The above embodiments may be implemented in whole or in part by software, hardware, firmware, or any combination thereof. When the above embodiments are implemented by using software, they may be implemented in a form of a computer program product in whole or in part. The computer program product includes one or more computer instructions. When computer program instructions are loaded and executed on a computer, processes or functions according to the embodiments of the present disclosure are generated in whole or in part. The computer may be a general-purpose computer, a dedicated computer, a computer network, or any other programmable apparatus. The computer instructions may be stored in a computer-readable storage medium or transmitted from one computer-readable storage medium to another computer-readable storage medium, for example, the computer instructions may be transmitted from a website site, computer, server, or data center to another website site, computer, server, or data center via wired (such as coaxial cable, fiber optic, digital subscriber line (DSL)) or wireless (such as infrared, radio, microwave, etc.) means. The computer-readable storage medium may be any available medium that can be accessed by the computer, or a data storage device, such as including a server or a data center that integrates one or more available mediums. The available medium may be a magnetic medium (e.g., a floppy disk, a hard disk or a magnetic tape), an optical medium (e.g., a digital video disk (DVD)) or a semiconductor medium (e.g., a solid state disk (SSD)), etc.

It should be understood that, in the various embodiments of the present disclosure, a size of serial numbers of the above processes does not imply an order of execution, and the execution order of the respective processes should be determined by their function and internal logic, but should not constitute any limitation on the implementation processes of the embodiments of the present disclosure.

Those skilled in the art may clearly understand that, for the convenience and brevity of the description, the specific working processes of the systems, apparatus and units described above may refer to the corresponding processes in the above method embodiments, which will not be repeated here.

The above description is only the specific implementation of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of claims.

1. A communication method, comprising:
reporting, by a terminal device, beam information in a case where a first condition is met, in a small data transmission (SDT).

2. The method according to claim 1, wherein reporting the beam information in the case where the first condition is met, comprises:
reporting beam measurement information or initiating a contention-based random access procedure based on a first event and/or a second event.

3. The method according to claim 2, wherein the first event comprises that a beam with best wireless link quality changes.

4. The method according to claim 3, wherein a manner of determining whether the beam with the best wireless link quality changes, comprises:
acquiring latest beam measurement results, to determine the beam with the best wireless link quality;
comparing whether the beam with the best wireless link quality is the same as a beam selected under a first operation, wherein the first operation comprises at least one of: a last measurement, a last initiation of a random access procedure, a last transmission using configured grant (CG); and
determining that the beam with the best wireless link quality changes, in a case where the beam with the best wireless link quality is not the same as the beam selected under the first operation.

5. The method according to claim 2, wherein the second event comprises at least one of:
wireless link quality of a beam with best wireless link quality being below a first threshold; or
there being wireless link quality of at least one beam above a second threshold.

6. The method according to claim 2, wherein the beam measurement information comprises at least one of:
an index of a first beam;
a list of indices of first beams, comprising indices of first N beams in order of wireless link quality from good to bad;
a list of indices of second beams, comprising a set of indices of beams meeting a third threshold; or
a beam measurement result corresponding to an index of a beam.

7. The method according to claim 2, wherein the beam measurement information is carried in a first media access control control element (MAC CE).

8. The method according to claim 7, further comprising:
triggering, by the terminal device, a scheduling request (SR) based on the first MAC CE in a case of no uplink transmission resource, to trigger a random access procedure to acquire an uplink transmission resource.

9. The method according to claim 1, further comprising:
receiving, by the terminal device, a first paging message of a current resident cell;
wherein the first paging message comprises at least one of: a terminal device identifier, or a mobile terminated (MT)-SDT indication.

10. The method according to claim 1, further comprising:
initiating, by the terminal device, a procedure of the SDT;
wherein the procedure of the SDT comprises:
transmitting first uplink data to a network device by using a first uplink resource.

11. The method according to claim 1, further comprising:
receiving, by the terminal device, first indication information, wherein the first indication information is used for indicating beam reporting-related information.

12. The method according to claim 11, wherein the beam reporting-related information comprises at least one of:
whether to start a beam reporting procedure; or
a beam reporting-triggered manner.

13. The method according to claim 12, wherein the beam reporting-triggered manner comprises event triggering, and the event triggering is used for indicating the terminal device to report beam measurement information or initiate a contention-based random access procedure based on a first event and/or a second event.

14. A terminal device, comprising: a processor and a memory, wherein the memory is configured to store a computer program, and the processer is configured to invoke and execute the computer program stored in the memory, to cause the terminal device to perform:
reporting beam information in a case where a first condition is met, in a small data transmission (SDT).

15. The terminal device according to claim 14, wherein the processer is configured to invoke and execute the computer program stored in the memory, to cause the terminal device further to perform:
reporting beam measurement information or initiating a contention-based random access procedure based on a first event and/or a second event.

16. The terminal device according to claim 15, wherein the second event comprises at least one of:
wireless link quality of a beam with best wireless link quality being below a first threshold; or
there being wireless link quality of at least one beam above a second threshold.

17. A network device, comprising: a processor and a memory, wherein the memory is configured to store a computer program, and the processer is configured to invoke and execute the computer program stored in the memory, to cause the network device to perform:
transmitting first indication information, wherein the first indication information is used for indicating beam reporting-related information.

18. The network device according to claim 17, wherein the beam reporting-related information comprises at least one of:
whether to start a beam reporting procedure; or
a beam reporting-triggered manner.

19. The network device according to claim 18, wherein the beam reporting-triggered manner comprises event triggering, and the event triggering is used for indicating the terminal device to report beam measurement information or initiate a contention-based random access procedure based on a first event and/or a second event.

20. The network device according to according to claim 19, wherein the second event comprises at least one of:
wireless link quality of a beam with best wireless link quality being below a first threshold; or
there being wireless link quality of at least one beam above a second threshold.
